(19) United States
(12) Patent Application Publication
(10) Pub. No.: US 2013/0262173 A1
(43) Pub. Date: Oct. 3, 2013

(54) PRIORITIZING CALENDER EVENTS

(71) Applicants: Li Chen, Cary, NC (US); David M. Stecher, Durham, NC (US); Lin Sun, Morrisville, NC (US)

(72) Inventors: Li Chen, Cary, NC (US); David M. Stecher, Durham, NC (US); Lin Sun, Morrisville, NC (US)

(73) Assignee: INTERNATIONAL BUSINESS MACHINES CORPORATION, Armonk, NY (US)

(21) Appl. No.: 13/435,577

(22) Filed: Mar. 30, 2012

(51) Int. Cl. G06Q 10/06

(52) U.S. Cl. 705/7.24

(57) ABSTRACT

Prioritizing events in electronic calendars, in one aspect, may automatically prioritize meetings based on the positions within an organization of the individuals attending, as well as the relationship among each of the individual meeting invitees.

### BACKGROUND

The present disclosure relates generally to prioritizing events in electronic calendars.

In various examples, prioritizing events in electronic calendars may be implemented in the form of systems, methods and/or algorithms.

### DESCRIPTION OF RELATED ART

Oftentimes in a modern business a great amount of an individual's time is spent in attending meetings. It is not uncommon, for example, for six or more hours of meetings to occur in a single day. In such an environment it can become extremely difficult to get any other work done. As such, individuals quite often begin skipping meetings in an attempt to get other work done. In doing so they usually use their best judgment as to what meetings are important, and what meetings are not. This is often effective, but it can also result in their missing important meetings if they misjudge.

### SUMMARY

In various embodiments, methodologies may be provided that automatically prioritize meetings based on the positions within an organization of the individuals attending, as well as the relationship among each of the individual meeting invitees.

In one specific example, the meetings may be prioritized by using a score (e.g., a quantitative score such as a number between 1 and 100). In another specific example, the meetings may be prioritized by using a category (e.g., a qualitative category such as “low”, “medium”, “high”).

As described herein, a user may be provided personalized feedback regarding how important a meeting is for that particular user. This may help the user realize if a meeting is more important or less important than that user had originally thought.

In one embodiment, a method implemented in a computer system for prioritizing calendar events in an electronic calendar is provided, the method comprising: receiving at least one meeting notice inviting at least a first receiver thereof to a meeting, the meeting notice providing a list of invitees; determining an importance within an organization for each invitee, wherein the importance within the organization for each invitee is determined at least in part by accessing data that is not included with the meeting notice; determining a relationship of each invitee relative to the first receiver of the meeting notice, wherein the relationship of each invitee relative to the first receiver is determined at least in part by accessing data that is not included with the meeting notice; assigning, for the first receiver, a priority score associated with the meeting notice based at least in part on the determined importance within the organization for each invitee and the determined relationship of each invitee relative to the first receiver; and providing to the first receiver, via the electronic calendar, the priority score associated with the meeting notice; wherein the providing to the first receiver the priority score includes providing to the first receiver an indication of each importance held by at least one of the invitees and an indication of a number of invitees having each importance.

In another embodiment a computer readable storage medium, tangibly embodying a program of instructions executable by the computer for prioritizing calendar events in an electronic calendar is provided, the program of instructions, when executing, performing the following steps: receiving at least one meeting notice inviting at least a first receiver thereof to a meeting, the meeting notice providing a list of invitees; determining an importance within an organization for each invitee, wherein the importance within the organization for each invitee is determined at least in part by accessing data that is not included with the meeting notice; determining a relationship of each invitee relative to the first receiver of the meeting notice, wherein the relationship of each invitee relative to the first receiver is determined at least in part by accessing data that is not included with the meeting notice; assigning, for the first receiver, a priority score associated with the meeting notice based at least in part on the determined importance within the organization for each invitee and the determined relationship of each invitee relative to the first receiver; and providing to the first receiver, via the electronic calendar, the priority score associated with the meeting notice; wherein the providing to the first receiver the priority score includes providing to the first receiver an indication of each importance held by at least one of the invitees and an indication of a number of invitees having each importance.

In another embodiment a computer-implemented system for prioritizing calendar events in an electronic calendar is provided, the system comprising: an input element receiving at least one meeting notice inviting at least a first receiver thereof to a meeting, the meeting notice providing a list of invitees; a calculation element configured to: (a) determine an importance within an organization for each invitee, wherein the importance within the organization for each invitee is determined at least in part by accessing data that is not included with the meeting notice; (b) determine a relationship of each invitee relative to the first receiver of the meeting notice, wherein the relationship of each invitee relative to the first receiver is determined at least in part by accessing data that is not included with the meeting notice; and (c) assign, for the first receiver, a priority score associated with the meeting notice based at least in part on the determined importance within the organization for each invitee and the determined relationship of each invitee relative to the first receiver; and an output element providing to the first receiver, via the electronic calendar, the priority score associated with the meeting notice; wherein the priority score includes an indication of each importance held by at least one of the invitees and an indication of a number of invitees having each importance.

### BRIEF DESCRIPTION OF THE DRAWINGS

Various objects, features and advantages of the present invention will become apparent to one skilled in the art, in view of the following detailed description taken in combination with the attached drawings, in which:

FIG. 1 depicts a flowchart according to one embodiment of the present invention;

FIG. 2 depicts a first example display output according to one embodiment of the present invention;

FIG. 3 depicts a second example display output according to one embodiment of the present invention;

FIG. 4 depicts a third example display output according to one embodiment of the present invention;

FIG. 5 depicts a block diagram of a system according to one embodiment of the present invention; and

FIG. 6 depicts a block diagram of a system according to one embodiment of the present invention.

### DETAILED DESCRIPTION

In one example, one or more systems may provide for prioritizing events in electronic calendars. In another example, one or more methods may provide for prioritizing events in electronic calendars. In another example, one or more algorithms may provide for prioritizing events in electronic calendars.

In one specific example, an algorithm may take into account a position, level and/or rank and relationship of the individuals invited to a meeting, the number of individuals invited to the meeting, and/or whether or not the meeting is recurring. The algorithm may use this information to scale the importance of the meeting for each individual invitee. Additional information may also be used such as (for example) past attendance history (e.g., for recurring meetings), how many of the invitees have accepted the invitation, who among the invitees has accepted the invitation and/or the topic of the meeting (using any desired known techniques).

For the purposes of describing and claiming the present invention the term “electronic calendar” is intended to refer to a software program or the like that has the capability of originating, accepting, arranging, organizing, tracking, scheduling and/or displaying one or more meetings (and/or proposed meetings) for a user thereof. In three specific examples (which are intended to be illustrative and not restrictive) an electronic calendar may be MICROSOFT OUTLOOK®, NOVEL GROUPWISE®, or LOTUS NOTES®.

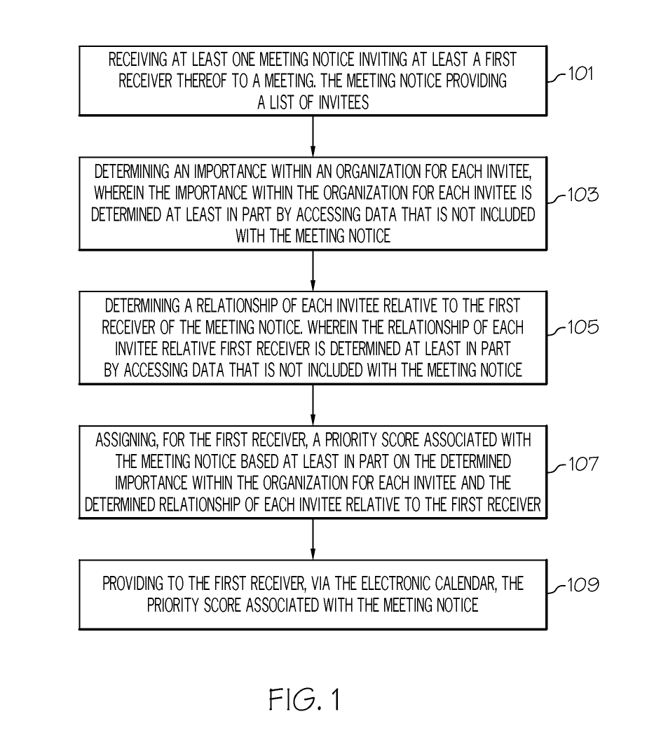

Referring now to FIG. 1, a method implemented in a computer system for prioritizing calendar events in an electronic calendar according to an embodiment of the present invention is shown. As seen in this FIG. 1, the method of this embodiment comprises: Step 101—receiving at least one meeting notice inviting at least a first receiver thereof to a meeting, the meeting notice providing a list of invitees (in one example, the list of invitees may comprise at least the receiver and one other invitee); Step 103—determining an importance within an organization for each invitee, wherein the importance within the organization for each invitee is determined at least in part by accessing data that is not included with the meeting notice; Step 105—determining a relationship of each invitee relative to the first receiver of the meeting notice, wherein the relationship of each invitee relative to the first receiver is determined at least in part by accessing data that is not included with the meeting notice; Step 107—assigning, for the first receiver, a priority score associated with the meeting notice based at least in part on the determined importance within the organization for each invitee and the determined relationship of each invitee relative to first receiver; and Step 109—providing to the first receiver, via the electronic calendar, the priority score associated with the meeting notice. In this embodiment, the providing to the first receiver the priority score includes providing to the first receiver an indication of each importance held by at least one of the invitees and an indication of a number of invitees having each importance. In one example, the number of invitees having each importance is an integer greater than zero. In another example, rather than providing an indication of each importance held by at least one of the invitees (that is, providing an indication for all of the importance values or levels) an indication may be provided for less than all (that is, a subset) of the importance values or levels.

In one example, the importance within an organization may be selected from the group including (but not limited to): (a) a job title; (b) a position in a hierarchical employment structure; (c) an amount of seniority; (d) an amount of education; (e) a salary; and/or (f) an age.

In one example, the providing to the receiver the priority score may comprise providing the priority score visually (e.g., on a computer display) and/or audibly (e.g., by a computer speaker).

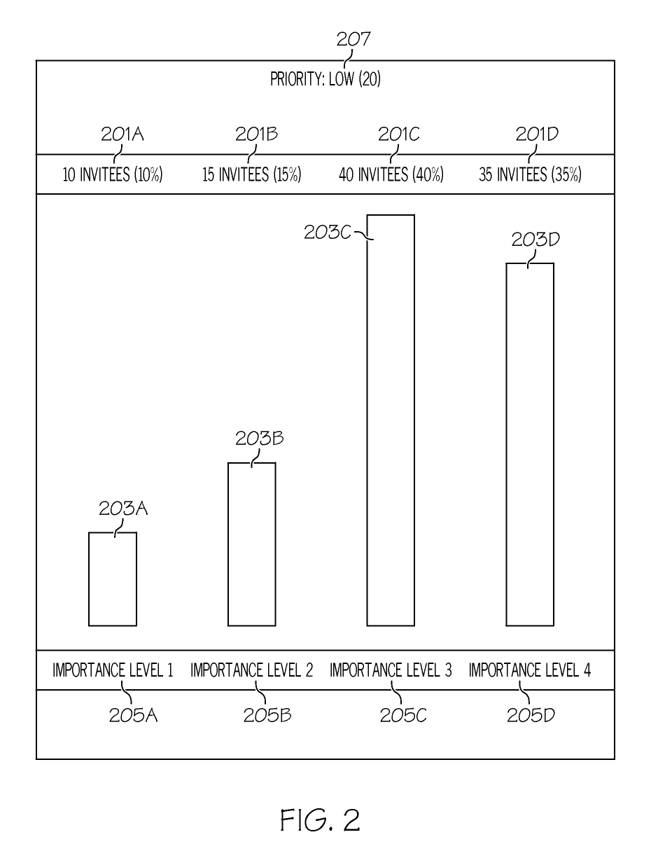

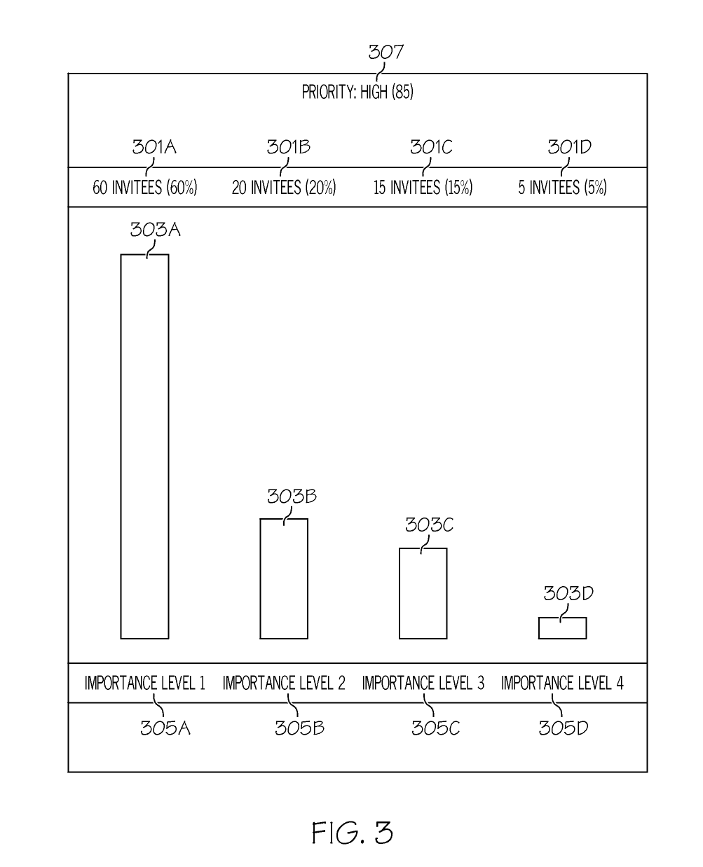

Reference will now be made to the histogram-type display outputs of FIGS. 2 and 3. In various examples, an indication of the number of invitees having each importance value or level (see text importance indicators 201A-201D and 301A-301D) may comprises at least one of: (a) an absolute value of the number of invitees having each importance value or level; and/or (b) a percentage value of the number of invitees having each importance value or level.

Further, graphical importance indicators (see 203A-203D and 303A-303D) indicating the number of invitees having each importance value or level may be provided.

In addition, text importance labels (see 205A-205D and 305A-305D) associated with each importance value or level may be provided (of course, the four importance levels (i.e., 1-4) shown in FIGS. 2 and 3 are intended to be illustrative examples, and are not restrictive).

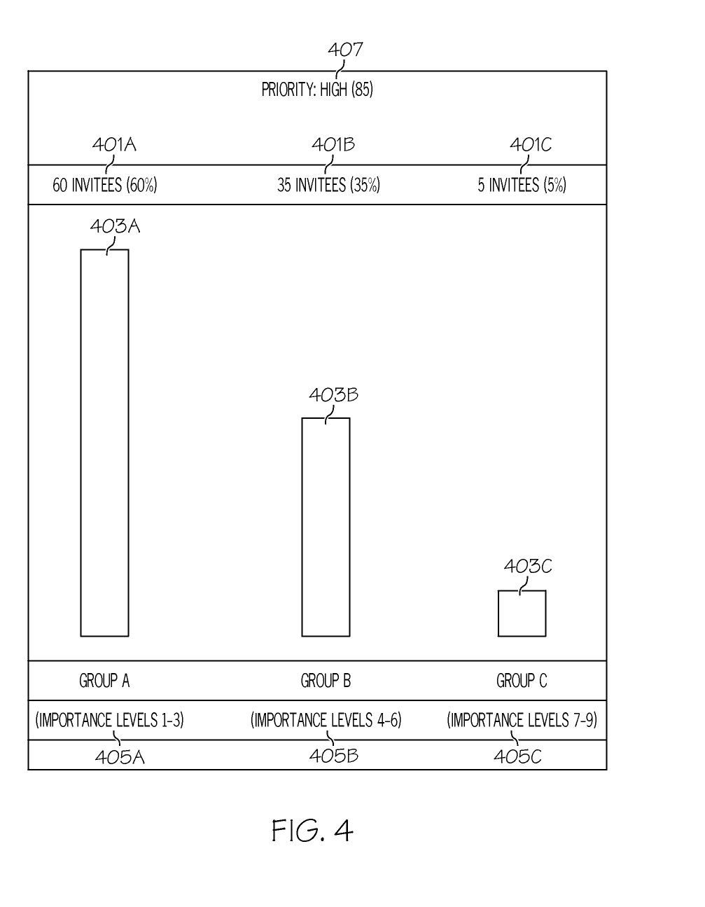

Moreover, while each of four individual importance levels are displayed in FIGS. 2 and 3, in another example, one or more importance levels may be grouped together into a range for display. In this regard, see FIG. 4, showing: at callout number 405A—Group A (that includes, e.g., importance levels 1-3); at callout number 405B—Group B (that includes, e.g., importance levels 4-6); and at callout number 405C—Group C (that includes, e.g., importance levels 7-9). In the case where one or more importance levels are grouped together, the number of invitees having an importance value or level within a given group may be counted toward the number displayed for such given group.

In another example, the priority score (see the text at callout numbers 207, 307 and 407 of FIGS. 2, 3 and 4) may comprise at least one of: (a) a quantitative score (e.g., a number between 0 and 100); and/or (b) a qualitative score (e.g., “Low” importance; “Medium” importance, “High” importance).

In another example, the determined importance within the organization for each invitee on the list of invitees is not disclosed to the receiver. In one specific example, this may be accomplished by filtering out (e.g., not displaying) meetings with only one other participant. In another specific example, this may be accomplished by keeping the workings of the importance determining algorithm from being transparent (e.g., hiding the workings of the importance determining algorithm so the end users are not aware of individual importance levels or values and/or are not aware of how the importance values or levels are calculated).

In another example, at least one of: (a) the importance within the organization for each invitee is determined by accessing data that is confidential; and/or (b) the relationship of each invitee relative to the receiver of the meeting notice is determined by accessing data that is confidential. In one specific example, the confidential data may be accessed from one or more hierchical/organizational database(s).

In another example, each invitee may be associated with the same organization.

In another example, at least a first one of the invitees may be associated with a first organization, at least a second one of the invitees may be associated with a second organization, and the first and second organizations may be different organizations.

In another example, the prioritization may be carried out without relying upon hierarchy visibility (e.g., by determining importance values or levels as described herein).

In another example, the prioritization may be carried out by analyzing the participants invited to a meeting (e.g., by determining importance values or levels as described herein).

In another example, the system(s), method(s) and or algorithm(s) may comprise: receiving at least one meeting notice inviting a plurality of receivers thereof to a meeting, the meeting notice providing a list of invitees; determining a relationship of each invitee on the list relative to each of the receivers of the meeting notice, wherein the relationship of each invitee relative to each of the receivers is determined at least in part by accessing data that is not included with the meeting notice; assigning, for each of the receivers, a priority score associated with the meeting notice based at least in part on the determined importance within the organization for each invitee and the determined relationship of each invitee relative to each respective receiver; and providing to each of the receivers, via an electronic calendar, a respective priority score associated with the meeting notice. In this example, the providing to each of the receives the respective priority score includes providing to each of the receivers an indication of each importance of at least one of the invitees and an indication of a number of invitees having each importance.

In another example, the determined importance within the organization for each invitee on the list of invitees is not disclosed to any of the receivers.

In other embodiments, systems, methods and algorithms for prioritizing calendar events in an electronic calendar are provided, comprising: receiving a meeting notice inviting a receiver thereof to a meeting, the meeting notice providing a list of invitees; determining an importance within an organization for each invitee on the list of invitees; determining a relationship of each of the invitees relative to the receiver of the meeting notice; determining a frequency of occurrence for the meeting in the meeting notice; aggregating the list of invitees, the importance information, the relationship information, and the frequency information; assigning an importance score to the meeting notice based on the aggregated information; determining a priority for the meeting notice based on the importance score; and advising the receiver of the priority of the meeting via the electronic calendar.

As described herein, various embodiments provide: (a) using hierchical/organizational data associated with one or more individuals to determine a priority (e.g., personalized for each associated individual) of a meeting (as compared, for example, to scheduling the meeting); (b) one or more statistics (e.g., personalized for each individual) showing the absolute value and/or the percentage of importance levels of the meeting participants (e.g., without disclosing each individual's actual identity); (c) scheduling based on individual information associated with each user's receiving a meeting invite, and keeping that information secret in the process; and/or (d) prioritizing a meeting based on the meeting invitation list of participants in addition to data not necessarily associated with the meeting invitation (such as the importance of the participant and/or his report chain)—such extrinsic information is not conventionally included in the invitation as one or more meeting attributes that are directly associated with the meeting.

As described herein, various embodiments provide for automatically prioritizing events in electronic calendars.

In another example, the steps may be carried out in the order recited or the steps may be carried out in another order.

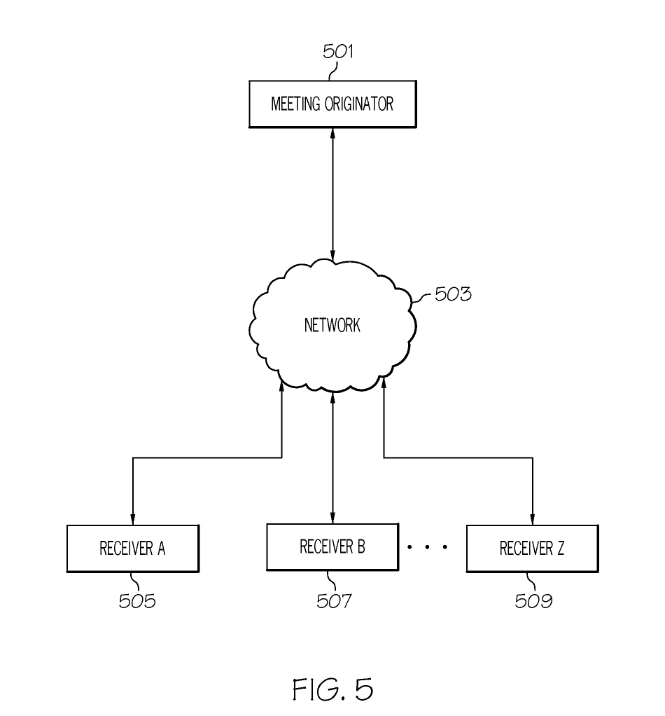

Referring now to FIG. 5, this figure depicts a block diagram of a system according to one embodiment of the present invention. As seen in this FIG. 5, Meeting Originator 501 may communicate via Network 503 (e.g., bi-directionally) with any (or all) of: Receiver A (shown with call-out number 505), Receiver B (shown with call-out number 507), through Receiver Z (shown with call-out number 509). Of course, any appropriate number of Receiver (s) may be communicated with. In addition, such Receivers may be invitees to a meeting originated by Meeting Originator 501.

Of note, while FIG. 5 shows the various entities communicating, it is to be understood that this FIG. 5 is actually referring to communication by computer system(s) or the like that are owned, leased, operated, used by, in the possession of, and/or controlled by each of the entities.

In other examples, Network 503 may comprise the Internet and/or one or more Intranets, Local Area Networks, Wide Area Networks, or the like.

In addition, in other examples, various entities (e.g., Meeting Originator and Receiver(s)) may be associated with the same organization or one or more different organizations.

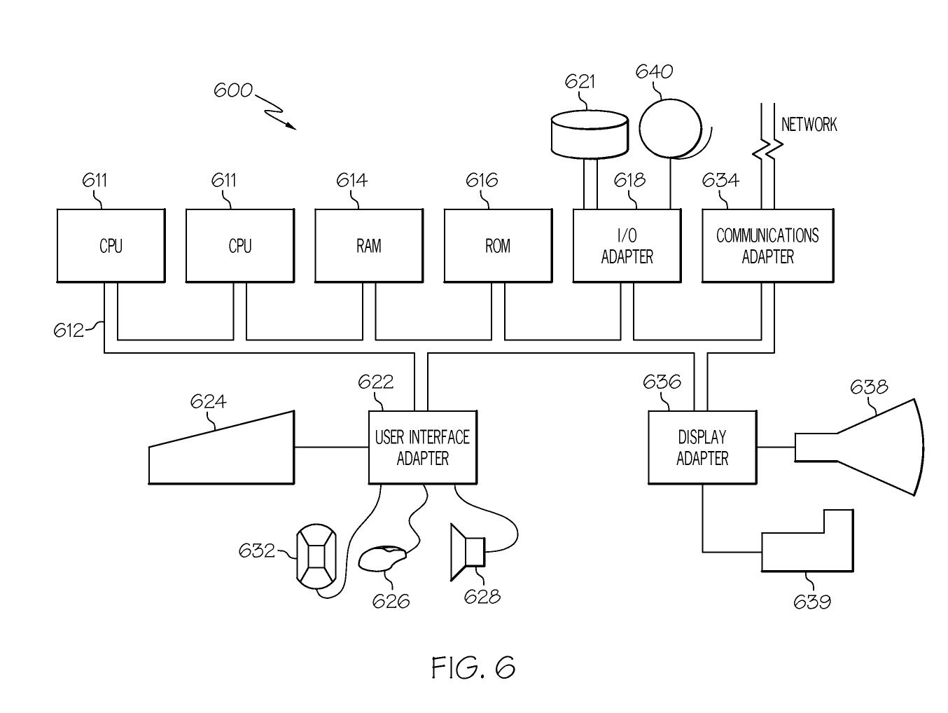

Referring now to FIG. 6, this figure shows a hardware configuration of computing system 600 according to an embodiment of the present invention. As seen, this hardware configuration has at least one processor or central processing unit (CPU) 611. The CPUs 611 are interconnected via a system bus 612 to a random access memory (RAM) 614, read-only memory (ROM) 616, input/output (I/O) adapter 618 (for connecting peripheral devices such as disk units 621 and tape drives 640 to the bus 612), user interface adapter 622 (for connecting a keyboard 624, mouse 626, speaker 628, microphone 632, and/or other user interface device to the bus 612), a communications adapter 634 for connecting the system 600 to a data processing network, the Internet, an Intranet, a local area network (LAN), etc., and a display adapter 636 for connecting the bus 612 to a display device 638 and/or printer 639 (e.g., a digital printer or the like).

In one specific example, an algorithm may function as follows. In every case (1)-(5) below, if one knows some or most of the attendees, the meeting could be highly interesting to that person, and the importance score could increase as the percent of people that person knows are invited to and/or accepted the meeting. Also, the degree of knowing someone can be used here to calculate the score. The more often a person communicates with someone, the individual score from that person should be high and thus affect the personalized importance score for the particular meeting. For example, is this someone with whom you communicate daily vs. someone with whom you only communicate once in a while? The statistics information may be drawn from various daily communication tools (for example, chat and/or text messaging, email, sametime, and/or the like).

(1) If there is a large number of people in the meeting and most of the people in the meeting are at a similar level, rank, or the like (sometimes referred to hereinafter simply as “band”) within the organization as the user then the meeting is likely not important (e.g., a team “open mic”) and no one may notice if the user does not join the meeting.

(2) If there is a large number of people in the meeting and most of them are at a similar band as the user, but there are one or two people at a higher band attending the meeting, the meeting is still likely not important, but more important than case (1). It is likely a department meeting, an executive round table, or the like. The user will likely not be singled out to speak, and so can safely skip, but may be missing interesting information from those higher up in the company.

(3) If there is a small number of people in the meeting, and they are at a similar band as the user the meeting is likely important. It is likely a technical meeting, code review, design discussion, or the like and the user should be present.

(4) If there is a small number of people in the meeting, and they are at a higher band than the user, the meeting is likely extremely important. It is likely a yearly employee review, 1 on 1 with a manager, or another such extremely important meeting.

(5) If a meeting is recurring, it in general should be ranked as less important: especially if the list of users does not change week to week. However, if a meeting is recurring and the participant list changes (e.g., a high level employee is attending a meeting that they do not normally attend) then the meeting is likely far more important than usual, and it would be very wise to attend.

In this example, the above information may be aggregated and used to assign a priority to the meeting. When this is complete, the user can specify how busy they are to their calendar (this function could also be tied algorithmically to the user's to do list) and the calendar notifies them which meetings that they can likely skip safely. This can aid in allowing them to catch up on their work and get to a place where they can again attend all of their meetings.

In another specific example, an information accessing and associating process may function as follows: (1) determine the identity of a number of individuals invited to a meeting; (2) loop through each individual invited to the meeting; and (3) access information (e.g., hierchical/organizational profile information) about each individual invited to the meeting; (4) associate, respectively, the accessed information (e.g., the profile data) with every individual in the meeting.

Based upon the information from the accessing and associating process described above, the following example algorithm may be applied to determine the relative importance of the meeting:

(1) Using the band of the participants: sum the band levels of the participants and divide them by the square of the number of participants. This ensures that as the number of participants increases, the importance of the meeting will decrease exponentially, while bands will still significantly factor into the overall importance of the meeting. Additionally, to further increase the importance of relative bands, each increase in band level may cause a co-efficient to be multiplied to the number. For example, multiply band 6 by 1, band 7 by 2, band 8 by 3, and so on when summing the overall band levels of those in the meeting. Subsequently return this value. Furthermore, the algorithm could be extended to take into account the band of the user who is viewing the meeting notice. One example algorithm would be to subtract (from an importance score for the meeting) the value of the individuals' bands who are at a lower band, and to add (to the importance score for the meeting) the value of the individuals' bands who are at an equal or higher band. This number could then be normalized based on a defined scale, e.g., between −100 and 100 to give a feel for if the meeting tends towards those at a lower band, those at a higher band, or those at an equal band.

(2) Take the score calculated by the ranking algorithm and present the importance to the user in a number of ways. For example: (a) simply normalize the score on a scale from 0 to 100 and present that as the meeting importance to the user; and/or (b) split all meetings on the user's calendar into separate groups and use these rankings to determine which group they fall into (for example, 33.3% fall into low priority, 33.3% fall into medium priority, and 33.3% fall into high priority).

As stated above, similar algorithms could rank the importance of the meeting using other factors like an amount of seniority and/or salary. If a company does not have data available like band to use for importance, salary would be a good indicator of importance within the company. An amount of seniority would possibly be an indicator of position within the company as well, but possibly less effective than salary.

Additionally, it is possible to present statistics to the user describing the overall balance of the meeting participants' positions within the company. It can be important to ensure that a user cannot determine the bands, salaries, ages, or the like of others from the meeting. Therefore, there could be a mechanism to prohibit a user from being able to simply put themselves in a meeting with only 1 other participant to determine this information. Further, the meeting information could only display how strongly the meeting is weighted towards users at a higher or lower position within the company. For example, this could be done by averaging the bands of those in the meeting, and normalizing that number on a scale from 0 to 100. That normalized number would determine how weighted the meeting is towards those at a higher band. Closer to 0 would indicate that you are at a high band relative to those in the meeting. Closer to 100 would indicate that you are at a lower band. Being able to glance at this number would indicate to the user how important the meeting may be. This approach allows the user to get a feel for the importance of the meeting based on information that they could not access if this algorithm did not expose it in a safe way.

In other examples, any steps described herein may be carried out in any appropriate desired order.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any programming language or any combination of one or more programming languages, including an object oriented programming language such as Java, Smalltalk, C++ or the like or a procedural programming language, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention may be described herein with reference to flowchart illustrations and/or block diagrams of methods, systems and/or computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus or other devices provide processes for implementing the functions/acts specified in the flowchart and/or block diagram block or blocks.

The flowcharts and block diagrams in the figures illustrate the architecture, functionality, and operation of possible implementations of systems, methods and computer program products according to various embodiments of the present invention. In this regard, each block in the flowcharts or block diagrams may represent a module, segment, or portion of code, which comprises one or more executable instructions for implementing the specified logical function(s). It should also be noted that, in some implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

It is noted that the foregoing has outlined some of the objects and embodiments of the present invention. This invention may be used for many applications. Thus, although the description is made for particular arrangements and methods, the intent and concept of the invention is suitable and applicable to other arrangements and applications. It will be clear to those skilled in the art that modifications to the disclosed embodiments can be effected without departing from the spirit and scope of the invention. The described embodiments ought to be construed to be merely illustrative of some of the features and applications of the invention. Other beneficial results can be realized by applying the disclosed invention in a different manner or modifying the invention in ways known to those familiar with the art. In addition, all of the examples disclosed herein are intended to be illustrative, and not restrictive.

1. A method implemented in a computer system for prioritizing calendar events in an electronic calendar, the method comprising:
receiving, by the computer system, at least one meeting notice inviting at least a first receiver thereof to a meeting, the meeting notice providing a list of invitees;
determining, by the computer system, an importance within an organization for each invitee, wherein the importance within the organization for each invitee is determined at least in part by accessing data that is not included with the meeting notice;
determining, by the computer system, a relationship of each invitee relative to the first receiver of the meeting notice, wherein the relationship of each invitee relative to the first receiver is determined at least in part by accessing data that is not included with the meeting notice;
assigning, by the computer system, for the first receiver, a priority score associated with the meeting notice based at least in part on the determined importance within the organization for each invitee and the determined relationship of each invitee relative to the first receiver; and
providing, by the computer system to the first receiver, via the electronic calendar, the priority score associated with the meeting notice;
wherein the providing to the first receiver the priority score includes providing to the first receiver an indication of each importance held by at least one of the invitees and an indication of a number of invitees having each importance.

2. The method of claim 1, wherein the indication of the number of invitees having each importance comprises at least one of: (a) an absolute value of the number of invitees having each importance; and (b) a percentage value of the number of invitees having each importance.

3. The method of claim 1, wherein the priority score comprises at least one of: (a) a quantitative score; and (b) a qualitative score.

4. The method of claim 1, wherein the determined importance within the organization for each invitee on the list of invitees is not disclosed to the receiver.

5. The method of claim 1, wherein at least one of:
(a) the importance within the organization for each invitee is determined by accessing data that is confidential; and
(b) the relationship of each invitee relative to the receiver of the meeting notice is determined by accessing data that is confidential.

6. The method of claim 1, further comprising:
receiving, by the computer system, the at least one meeting notice, wherein the meeting notice invites a plurality of receivers thereof to a meeting, and the meeting notice provides a list of invitees;
determining, by the computer system, a relationship of each invitee on the list relative to each of the receivers of the meeting notice, wherein the relationship of each invitee relative to each of the receivers is determined at least in part by accessing data that is not included with the meeting notice;
assigning, by the computer system, for each of the receivers, a priority score associated with the meeting notice based at least in part on the determined importance within the organization for each invitee and the determined relationship of each invitee relative to each respective receiver; and
providing, by the computer system to each of the receivers, via a respective electronic calendar, a respective priority score associated with the meeting notice;
wherein the providing to each of the receivers the respective priority score includes providing to each of the receivers an indication of each importance held by at least one of the invitees and an indication of a number of invitees having each importance.

7. The method of claim 1, wherein the steps are carried out in the order recited.

8. A computer readable storage device, tangibly embodying a program of instructions executable by the computer for prioritizing calendar events in an electronic calendar, the program of instructions, when executing, performing the following steps:
receiving at least one meeting notice inviting at least a first receiver thereof to a meeting, the meeting notice providing a list of invitees;
determining an importance within an organization for each invitee, wherein the importance within the organization for each invitee is determined at least in part by accessing data that is not included with the meeting notice;
determining a relationship of each invitee relative to the first receiver of the meeting notice, wherein the relationship of each invitee relative to the first receiver is determined at least in part by accessing data that is not included with the meeting notice;
assigning, for the first receiver, a priority score associated with the meeting notice based at least in part on the determined importance within the organization for each invitee and the determined relationship of each invitee relative to the first receiver; and
providing to the first receiver, via the electronic calendar, the priority score associated with the meeting notice;
wherein the providing to the first receiver the priority score includes providing to the first receiver an indication of each importance held by at least one of the invitees and an indication of a number of invitees having each importance.

9. The computer readable storage device of claim 8, wherein the indication of the number of invitees having each importance comprises at least one of: (a) an absolute value of the number of invitees having each importance; and (b) a percentage value of the number of invitees having each importance.

10. The computer readable storage device of claim 8, wherein the priority score comprises at least one of: (a) a quantitative score; and (b) a qualitative score.

11. The computer readable storage device of claim 8, wherein the determined importance within the organization for each invitee on the list of invitees is not disclosed to the receiver.

12. The computer readable storage device of claim 8, wherein at least one of:
(a) the importance within the organization for each invitee is determined by accessing data that is confidential; and
(b) the relationship of each invitee relative to the receiver of the meeting notice is determined by accessing data that is confidential.

13. The computer readable storage device of claim 8, further comprising:
receiving the at least one meeting notice, wherein the meeting notice invites a plurality of receivers thereof to a meeting, and the meeting notice provides a list of invitees;
determining a relationship of each invitee on the list relative to each of the receivers of the meeting notice, wherein the relationship of each invitee relative to each of the receivers is determined at least in part by accessing data that is not included with the meeting notice;
assigning, for each of the receivers, a priority score associated with the meeting notice based at least in part on the determined importance within the organization for each invitee and the determined relationship of each invitee relative to each respective receiver; and
providing to each of the receivers, via a respective electronic calendar, a respective priority score associated with the meeting notice;
wherein the providing to each of the receivers the respective priority score includes providing to each of the receivers an indication of each importance held by at least one of the invitees and an indication of a number of invitees having each importance.

14. The computer readable storage device of claim 8, wherein the steps are carried out in the order recited.

15. A computer-implemented system for prioritizing calendar events in an electronic calendar, the system comprising:
an input element comprising hardware, the input element being configured to receive at least one meeting notice inviting at least a first receiver thereof to a meeting, the meeting notice providing a list of invitees;
a calculation element comprising hardware, the calculation element being configured to:
(a) determine an importance within an organization for each invitee, wherein the importance within the organization for each invitee is determined at least in part by accessing data that is not included with the meeting notice;
(b) determine a relationship of each invitee relative to the first receiver of the meeting notice, wherein the relationship of each invitee relative to the first receiver is determined at least in part by accessing data that is not included with the meeting notice; and
(c) assign, for the first receiver, a priority score associated with the meeting notice based at least in part on the determined importance within the organization for each invitee and the determined relationship of each invitee relative to the first receiver; and
an output element comprising hardware, the output element being configured to provide to the first receiver, via the electronic calendar, the priority score associated with the meeting notice;
wherein the priority score includes an indication of each importance held by at least one of the invitees and an indication of a number of invitees having each importance.

16. The system of claim 15, wherein the indication of the number of invitees having each importance comprises at least one of: (a) an absolute value of the number of invitees having each importance; and (b) a percentage value of the number of invitees having each importance.

17. The system of claim 15, wherein the priority score comprises at least one of: (a) a quantitative score; and (b) a qualitative score.

18. The system of claim 15, wherein the determined importance within the organization for each invitee on the list of invitees is not disclosed to the receiver.

19. The system of claim 15, wherein at least one of:
(a) the importance within the organization for each invitee is determined by accessing data that is confidential; and
(b) the relationship of each invitee relative to the receiver of the meeting notice is determined by accessing data that is confidential.

20. The system of claim 15, further comprising:
receiving by the input element the at least one meeting notice, wherein the meeting notice invites a plurality of receivers thereof to a meeting, and the meeting notice provides a list of invitees;
determining by the calculation element a relationship of each invitee on the list relative to each of the receivers of the meeting notice, wherein the relationship of each invitee relative to each of the receivers is determined at least in part by accessing data that is not included with the meeting notice;
assigning by the calculation element, for each of the receivers, a priority score associated with the meeting notice based at least in part on the determined importance within the organization for each invitee and the determined relationship of each invitee relative to each respective receiver; and
providing by the output element to each of the receivers, via a respective electronic calendar, a respective priority score associated with the meeting notice;
wherein the providing to each of the receivers the respective priority score includes providing to each of the receivers an indication of each importance held by at least one of the invitees and an indication of a number of invitees having each importance.
